(19) United States
(12) Patent Application Publication
(10) Pub. No.: US 2009/0152473 A1
(43) Pub. Date: Jun. 18, 2009

(54) Photon source comprising an ecr source with pressure gradient

(75) Inventors: Denis Hitz, Grenoble (FR); Marc Delaunay, Meylan (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Commissariat A L'Energie Atomique, Paris (FR)

(21) Appl. No.: 10/582,515

(22) PCT Filed: May 11, 2006
(86) PCT No.: PCT/FR06/50429

§ 371 Date: Jun. 9, 2006

(30) Foreign Application Priority Data
May 13, 2005 (FR) 0551256

(51) Int. Cl. H01J 27/00; H01J 7/24

(52) U.S. Cl. 250/423 R; 315/111.21

(57) ABSTRACT

The invention relates to a photon source comprising an electron cyclotron resonance (ECR) multicharged ion plasma source, the multicharged ions corresponding to several charge states of a first constituent (g1) inserted into a vacuum chamber (CH), and at least one charge state emitting photons with a wavelength λₒ by de-excitation, wherein means set up a pressure gradient within the chamber (CH) of the first constituent (g1) and/or at least one second constituent (g2) different from the first constituent (g1), the pressure gradient being capable of creating an energy gradient of plasma electrons such that additional multicharged ions are created emitting photons with a wavelength equal to approximately λₒ by de-excitation.

### TECHNICAL DOMAIN AND PRIOR ART

This invention relates to a photon source and more particularly, a photon source comprising an electron cyclotron resonance (ECR) multicharged ion plasma source, more commonly called an ECR source.

For example, one application of the photon source according to the invention is the production of EUV (Extreme Ultra-Violet) photons for use in lithography.

Different light sources are used for EUV lithography, for example such as laser-produced plasma (LPP), synchrotron light, discharge sources (Z-pinch, hollow cathode, capillary source). These EUV sources have the following problems, depending on the case:
pulsed operation and power too low for some lasers;
production of debris that can be harmful to optics (mirrors);
high cost (lasers, synchrotron);
severe pumping;
mediocre reproducibility and life of the source.

Radiofrequency plasmas, more commonly called RF plasmas, are not very much used to make EUV photon sources because the electronic density in them is fairly low. To overcome this problem, American patent application US 2003 0006708 (see reference [1]) proposes a photon source that combines an RF plasma and an ECR plasma. In this patent application, it is considered that the magnetic structure that leads to electron cyclotron resonance is complicated to make. One solution without such a structure is then proposed. The photon source obtained comprises few charge states (see FIG. 1) and a single element emits photons with the required wavelength. One disadvantage of this photon source is the low power that it outputs, that is of the order of one milliwatt.

More recently, a source of EUV photons that uses de-excitation of multicharged ions produced by an ECR source was proposed (see reference [2]). The divulged photon source produces photons with a wavelength of 13.5 nm starting from de-excitation of Xe¹⁰⁺ ions. Due to their short wavelength, the emitted photons can advantageously be used to make etching smaller than 65 nm. However, one disadvantage of this photon source is the lower emitted power, namely 100 mW in 2π steradians.

However, a photon source that uses an ECR source has many advantages over the light sources mentioned above:
continuous and stable operation;
no output debris;
no wear (very long usage time due to the lack of a filament or cathode);
low pressure (10⁻⁵-10⁻⁴ mbars) to limit the dimensions of pumps and any vibrations;
low cost, if the magnetic structure is made from permanent magnets.

However, as already mentioned above, a major problem of a photon source that produces photons from an ECR source is the low power that it emits. The invention does not describe this disadvantage.

### Presentation of the Invention

The invention relates to a photon source comprising an electron cyclotron source (ECR) multicharged ion plasma source, the multicharged ions corresponding to several charge states of a first constituent inserted into a vacuum chamber, and at least one charge state emitting photons with a wavelength λₒ by de-excitation. The photon source also includes means of setting up a pressure gradient within the chamber of the first constituent and/or at least one second constituent different from the first constituent, the pressure gradient being capable of creating an energy gradient of plasma electrons such that additional multicharged ions corresponding to at least one charge state of the first constituent and/or at least one charge state of the second constituent are created in the chamber, the additional multicharged ions emitting photons with a wavelength equal to approximately λₒ by de-excitation.

According to another characteristic of the invention, the means of setting up a pressure gradient include a first diaphragm located on a first side of the chamber and a second diaphragm located on a second side of the chamber opposite the first side, in which there is an aperture through which photons are extracted from the photon source.

According to another characteristic of the invention, the second diaphragm comprises a central orifice through which photons are extracted from the photon source and pumping holes distributed around the central orifice, the diameter of the pumping holes being chosen to prevent microwaves injected into the cylindrical chamber under a vacuum from leaving the chamber, the number of pumping holes being chosen in relation with the hole diameter to set up a pressure value of the first constituent and/or the second constituent in a zone of the chamber located close to the second diaphragm.

According to another characteristic of the invention, the second diaphragm is made of a conducting material and it is polarised either to capture ions on impact zones and to transfer electrons to the plasma, or to capture electrons on impact zones and to transfer ions to the plasma.

According to another characteristic of the invention, the photon source includes Q additional diaphragms placed between the first and the second diaphragms such that the chamber is divided into Q+1 zones.

According to another characteristic of the invention, each of the Q additional diaphragms comprises an aperture with a size greater than a cut-off wavelength of microwaves injected into the chamber.

According to another characteristic of the invention, the shape of the aperture of each of the Q additional diaphragms is such that it does not intercept the lines of a magnetic field present in the chamber, thus leaving plasma particles free to circulate between the Q+1 zones.

According to another characteristic of the invention, at least one additional diaphragm is made from a conducting material and is polarised to capture or to transfer ions or electrons to the plasma.

According to another characteristic of the invention, the first constituent and/or the second constituent are inserted into at least one of the Q+1 zones of the chamber.

According to another characteristic of the invention, the chamber is in a truncated cone shape and participates in the means of setting up the pressure gradient.

According to another characteristic of the invention, the source comprises pumping means that participate in the means of setting up a pressure gradient.

According to another characteristic of the invention, the source comprises means of introducing additional electrons into the chamber.

According to another characteristic of the invention, the first constituent and/or the second constituent is a gas or a metal vapour.

According to another characteristic of the invention, a magnetic structure that participates in the multicharged ion plasma source comprises two cylindrical magnetic structures with axial confinement of the magnetic field and a cylindrical magnetic structure with radial confinement of the magnetic field that surrounds the chamber and that is located between the two cylindrical magnetic structures with axial confinement, a first cylindrical magnetic structure with axial confinement being located at a first end of the chamber and the second cylindrical magnetic structure with axial confinement being located at a second end of the chamber where the photons are extracted from the source.

According to another characteristic of the invention, at least one additional cylindrical magnetic structure with axial confinement is located between the two cylindrical magnetic structures with axial confinement located at the two ends of the chamber.

According to another characteristic of the invention, the cylindrical magnetic structures with axial confinement and the additional cylindrical magnetic structure with axial confinement are composed of superconducting coils.

According to another characteristic of the invention, the cylindrical magnetic structure with radial confinement is composed of superconducting coils.

According to another characteristic of the invention, the superconducting coils that form the cylindrical magnetic structure with radial confinement are located inside the superconducting coils that form magnetic structures with axial confinement.

According to another characteristic of the invention, the superconducting coils that form the cylindrical magnetic structure with radial confinement are outside the superconducting coils that form the magnetic structures with axial confinement.

According to another characteristic of the invention, the superconducting coils that form the cylindrical magnetic structure with radial confinement are “racetrack” type coils.

According to another characteristic of the invention, the cylindrical magnetic structure with radial confinement is composed of permanent magnets.

According to another characteristic of the invention, the inside diameter of the cylindrical magnetic structure with axial confinement located at the second end of the chamber increases with increasing distance from the inside of the chamber towards the exit from the chamber.

According to another characteristic of the invention, the wavelength λₒ is equal to approximately 13.5 nm.

As a non-limitative example, a typical photon source according to the invention outputs a photonic power of the order of a few tens of watts in 4π steradians.

### BRIEF DESCRIPTION OF THE FIGURES

Other characteristics and advantages of the invention will become clearer after reading the following description with reference to the appended drawings, where:

FIG. 1 shows a typical electron density distribution curve in an ECR plasma as a function of the electron temperature;

FIG. 2 shows an electron density distribution curve in an ECR plasma as a function of the ionisation potential of constituents with atomic number less than 36;

FIGS. 3, 5-8 and 10-14 show different variants of photon sources according to the invention;

FIG. 4 shows a detailed view of an element of the photon source showed in FIG. 3;

FIGS. 9A and 9B show detailed views of elements of the photon source shown in FIG. 8;

FIGS. 15 to 17 show different magnetic structures that can be used in a photon source according to the invention;

FIG. 18, within the framework of the invention, shows an electron density distribution curve in an ECR plasma as a function of the ionisation potential of constituents with an atomic number less than 36.

The same marks denote the same elements in all figures.

### DETAILED DESCRIPTION OF EMBODIMENTS OF THE INVENTION

The photon source according to the invention comprises an ECR source.

Production of multicharged ions in an ECR source is described in many patents and articles. For example, reference [3] describes the manufacture of an ECR source made entirely from permanent magnets producing a strong flow of Xe¹⁰⁺ ions to be extracted so as to create an ion beam.

In general, ECR sources are continuous or pulsed sources of multicharged ions in which several charge states of a given species take place. Those skilled in the art designing an ECR source will attempt to obtain a plasma with a narrow electron energy distribution function so as produce a particular charge state in large quantities by electron/ion collision. For example, the Pb²⁷⁺ ion is produced by the ion source of the CERN LHC particle accelerator (LHC stands for Large Hadron Collider).

The electronic population in any ECR plasma with a closed resonance surface is not monokinetic and can be represented by a distribution function.

An ECR plasma thus contains electrons at a few eV (called “cold electrons”), at several hundred eV (called “warm electrons”) and at a few keV (called “hot electrons”), or even several hundred keV (called “very hot electrons”).

All these electrons (except for very high energy electrons) contribute to the production of multicharged ions. In order to tear off an additional electron from a multicharged ion, collisions have to take place between this ion and electrons. Effective ionisation cross-sections (or probabilities) by electronic impact may be determined experimentally or by calculation (for example see reference [4]). As a first approximation, it can be said that a maximum efficiency occurs when the energy of electrons is equal to three times the ionisation potential of the ion.

Thus, the maximum of the electron energy distribution function must be about 700 eV in order to produce a greater number of Xe¹⁰⁺ ions, while it must be about 10 keV to efficiently contribute to the production of Xe³⁰⁺ ions.

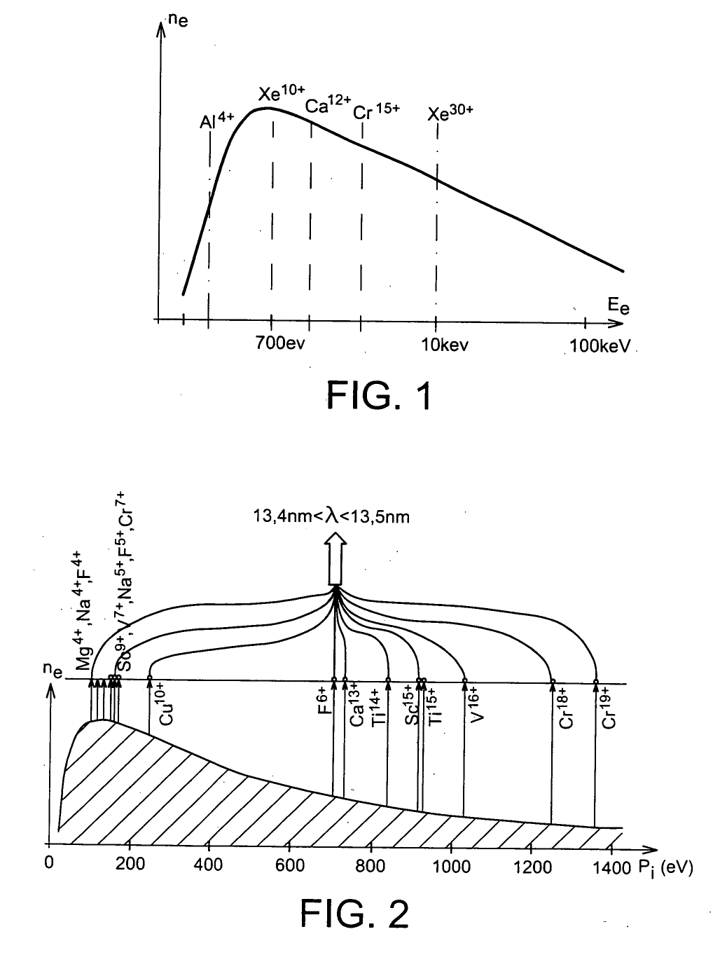

As non-limitative examples, FIG. 1 contains a few values of the electron energy Ee that are necessary to produce some specific ions, namely:
Ee=300 eV to produce the Al⁴⁺ ion,
Ee=700 eV to produce the Xe¹⁰⁺ ion,
Ee=2.7 keV to produce the Ca¹⁵⁺ ion,
Ee=10 keV to produce the Xe³⁰⁺ ion.

The electron density curve ne includes a maximum that depends strongly on plasma parameters, particularly the pressure of the various -elements that form the plasma and the power of hyperfrequency waves injected into the chamber.

Some of the various collisions that occur within the plasma lead to excitation of multicharged ions present in the plasma. This is the case particularly for electron/ion collisions. The effective cross-section or probability of this process may be determined experimentally or by calculation programs. Plasma electrons thus perform a double role as a function of their energy; they create and excite multicharged ions. Excited ions return to a stable state and emit photons at the same time.

Table 1 below gives a few examples of possible transitions, close to 13 nm, for elements with an atomic number Z less than 36.

TABLE 1

| Wavelength | | | |
|---|---|---|---|
| (nm) | Element (Z) | Charge | Transition |
| 13.0411 | Al (13) | 4+ | 2s² 2p⁴ (³P) 3s-2s² 2p⁵ |
| 13.0847 | Al (13) | 4+ | 2s² 2p⁴ (³P) 3s-2s² 2p⁵ |
| 13.0952 | Sc (21) | 12+ | 2s 2p⁶-2s² 2p⁵ |
| 13.1438 | Al (13) | 4+ | 2s² 2p⁴ (³P) 3s-2s² 2p⁵ |
| 13.1500 | Cr (24) | 19+ | 2s 2p²-2s² 2p |
| 13.1633 | K (19) | 8+ | 2p⁶ 4p-2p⁶ 3s |
| 13.1638 | Cr (24) | 7+ | 3s² 3p⁴ 4s-3s² 3p⁵ |
| 13.1880 | K (19) | 8+ | 2p⁶ 4p-2p⁶ 3s |
| 13.2171 | Mg (12) | 4+ | 2s² 2p³ 3s-2s² 2p⁴ |
| 13.3162 | Na (11) | 4+ | 2s² 2p² 3d-2s² 2p³ |
| 13.3395 | Cr (24) | 7+ | 3s² 3p⁴ 4s-3s² 3p⁵ |
| 13.4914 | Cu (29) | 10+ | 3p⁵ 3f-3p⁶ |

The first step to create a plasma composed of A^{q+} ions in an ECR source is to inject or to create a vapour of constituent A. For the case of gaseous elements (H, He, N, O, Ar, Kr, Xe, etc.), a simple gas cylinder provided with a valve is connected to the plasma chamber. The first step in producing ions from solid metallic elements is to create a vapour. This metallic vapour may be produced by different techniques well known in ECR ion sources.

The emitted photon intensity is directly related to the ion density of the constituents, which itself depends on the local pressure of these constituents. Thus for example, the pressure at which the density of Ar⁸⁺ ions is optimum is different from the pressure at which the density of O⁶⁺ ions is optimum.

FIG. 2 shows a non-limitative example of an electron density distribution curve nₑ in an ECR plasma as a function of the ionisation potential Pi of constituents with atomic number Z less than 36 capable of outputting photons with a wavelength between 13.4 nm and 13.5 nm. Plasma ions that emit photons at the required wavelength are Mn⁵⁺, Cr⁷⁺, Mg⁴⁺, Na⁴⁺, F⁴⁺, Sc⁹⁺, V⁷⁺, Na⁵⁺, F⁵⁺, Cu¹⁰⁺, F⁶⁺, Ca¹³⁺, Ti¹⁴⁺, SC¹⁵⁺, Ti¹⁵⁺, V¹⁶⁺, Cr¹⁸⁺, Cr¹⁹⁺ ions, with increasing ionisation potential.

An essential characteristic of the invention consists of modifying the electron density distribution of the plasma present in the chamber so as to create additional multicharged ions that emit photons at the required wavelength by de-excitation.

It is then possible to very significantly increase the photon emission power from the ECR plasma using the wide distribution of energy of electrons in the plasma. Several constituents may then be ionised and deliver a photon power at the required wavelength, by de-excitation of the ions thus formed. These constituents or species may be any element in the periodic table and several charge states can be used within each species.

Different photon source variants according to the invention will now be described.

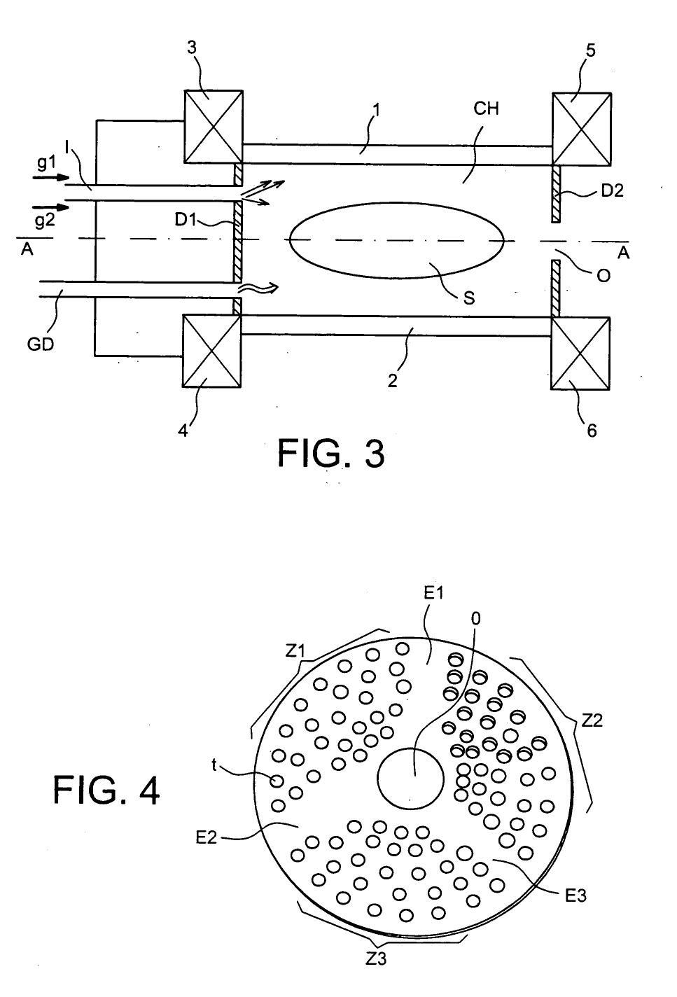

FIG. 3 shows a sectional view of a first variant of a photon source according to the invention.

The photon source includes a cylindrical plasma vacuum chamber CH with axis AA surrounded by a magnetic structure 1-6.

In a manner known in itself, the magnetic structure 1-6 comprises two cylindrical magnetic structures with axial confinement [3, 4] and [5, 6] and a cylindrical magnetic structure with radial confinement [1, 2]. A first cylindrical structure with axial confinement [3, 4] is located at a first end of the chamber while the second structure [5, 6] is located at the other end, the radial confinement structure being located between the two structures with axial confinement. Each structure with axial confinement gives a maximum value of the magnetic field. A microwave injection guide GD provided with a sealing window (not shown in the figure) injects microwaves into the chamber CH. A closed surface S, with no contact with the walls of the chamber and on which the value of the magnetic field is approximately equal to the value B_{RCE} of the ECR resonance field is present inside the chamber CH.

A gas injection device I injects at least one gas into the chamber CH. A multicharged ion plasma corresponding to a distribution of the charge state of a first gas g1 is formed inside the chamber CH. By de-excitation of multicharged ions, photons with various wavelengths λ are emitted in the chamber, and in particular photons with a wavelength λₒ (for example λₒ=13.5 nm).

Two diaphragms D1 and D2 located on each side of the chamber CH create a pressure gradient inside the chamber which, when applied to the gas g1 and/or to a second gas g2 different from the gas g1, broadens the energy distribution of electrons in the chamber CH, thus making it possible to obtain additional multicharged ions corresponding to at least one charge state of the gas g1 and/or at least one charge state of the gas g2 and capable of emitting photons with a wavelength equal to approximately λₒ, by de-excitation.

It is thus possible to very significantly increase the quantity of photons emitted at wavelength λₒ along the AA axis, through an aperture O formed in the diaphragm D2. The shape of the diaphragm D2 is preferably chosen so as to not disturb emission of photons, as described below with reference to FIG. 4. Advantageously, the diaphragm D2 may be made from a conducting material that is polarised to stop ions before they exit from the source.

Gases g1 and g2 may be added into the plasma chamber through the same injection device I, as shown in FIG. 3. They may also be added through different injection devices. The different injection devices can then be placed in different locations corresponding to different pressure values. FIG. 3 shows an example system for injecting two gases into a high pressure zone, thus facilitating the production of low charge states.

FIG. 4 shows an example of a diaphragm D2 located adjacent to the extraction of photons, in the case in which the radial magnetic field is hexapolar. The diaphragm D2 comprises a central aperture O through which photons are extracted from the source and pumping holes t. The pumping holes t are placed in three zones Z1, Z2 and Z3 separated from each other by zones E1, E2, E3 in which there are no holes and that are located at approximately 120° from each other. The zones E1, E2 and E3 are plasma impact zones and principally form zones in the diaphragm that limit leaks of the plasma. In the more general case in which the radial magnetic field is composed of 2N poles, the pumping holes t are arranged in N zones Z1, Z2, . . . , ZN separated from each other by N zones E1, E2, . . . , EN located at 360°/N from each other.

The diameter of the central aperture O depends on the size of the plasma, which depends on the intensity of the magnetic fields present in the chamber and the frequency of microwaves. The diameter of the central aperture O also depends on the position of the device that retrieves photons (not shown in the Figures). The hole diameter t is chosen to be sufficiently small to prevent microwave leaks. As a non-limitative example, the diameter of the holes may be equal to 2 mm while the frequency of the microwaves varies from 2 GHz to 100 GHZ, corresponding to a variation of the wavelength of 14 cm to 0.3 cm. For a fixed hole diameter, the number of holes is then chosen as a function of the required pressure in the chamber close to the diaphragm D2.

In general, the size of the apertures formed in the diaphragm D2 (which is on the photon extraction side) and the size of the apertures formed in the diaphragm D1 (which is on the side opposite the photon extraction side) are designed to obtain a “low” pressure on the extraction side of the photons and a “high” pressure on the other side. Consequently, orifices formed in diaphragm D1 are preferably chosen to be as small as possible. As a non-limitative example, a pressure of 10⁻⁴ mbars may be created on the constituent injection end, facilitating creation of the Cr⁷⁺ ion, while a pressure of 10⁻⁶ mbars or 10⁻⁷ mbars is set up at the photon extraction end, facilitating creation of the Cr¹⁹⁺ ion.

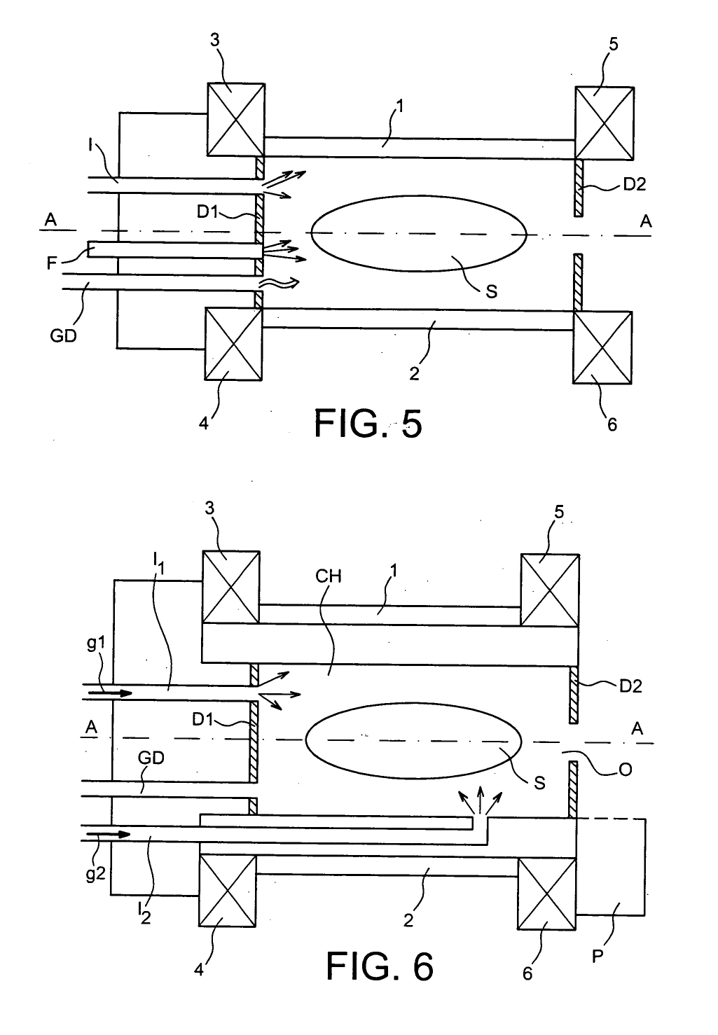

FIG. 5 shows a second variant of the photon source according to the invention. Apart from the gases g1 and/or g2, the photon source comprises at least one furnace F to create a metallic vapour that is injected into the chamber. The pressure gradient that is set up due to the presence of diaphragms D1 and D2 is then adapted to increase the density of multicharged metallic ions that emit photons at the required wavelength by de-excitation. It is then possible to create Al⁴⁺ and Cr¹⁹⁺ ions, for example, that are used for emissions of photons at 13.04 nm and 13.15 nm respectively (see table above).

The metallic vapours can also be injected into the chamber CH by other known means, for example by sputtering.

FIG. 6 shows a third variant of the photon source according to the invention. A gas inlet g1 is placed at the microwave injection end, at the diaphragm D1. The pressure in this region of the chamber is high. An inlet of gas g2 is placed at the photon extraction end where the pressure is lower. The gas g1 then gives ions of a first species with low charge states while the gas g2 gives ions of a second species with high charge states. Gases g1 and g2 may be identical or different.

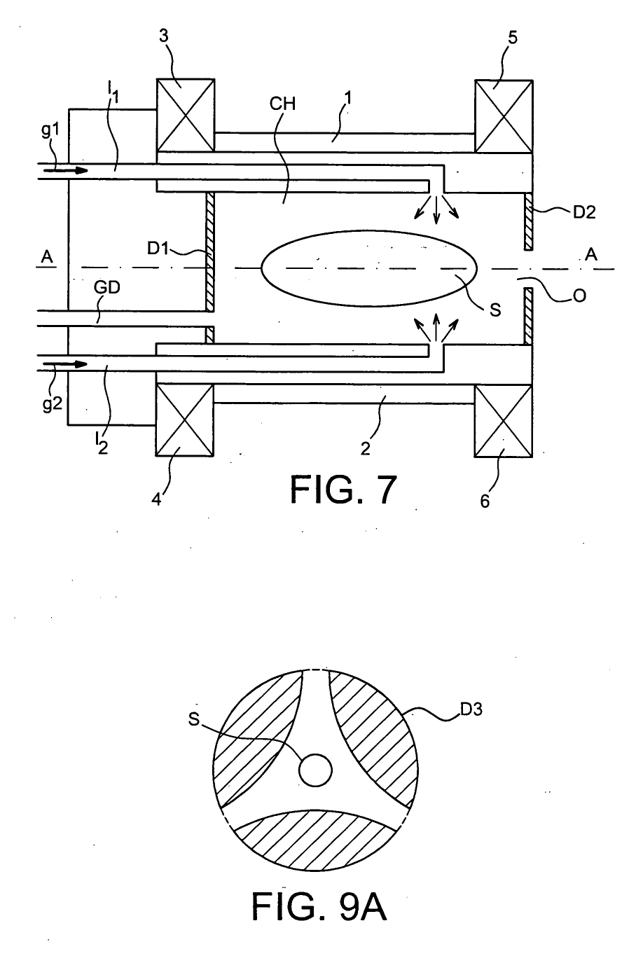

FIG. 7 shows a fourth variant of a photon source according to the invention. All gas and/or metallic vapour inlets are placed at the photon extraction end where the pressure is low. High charge states of each species can then be produced.

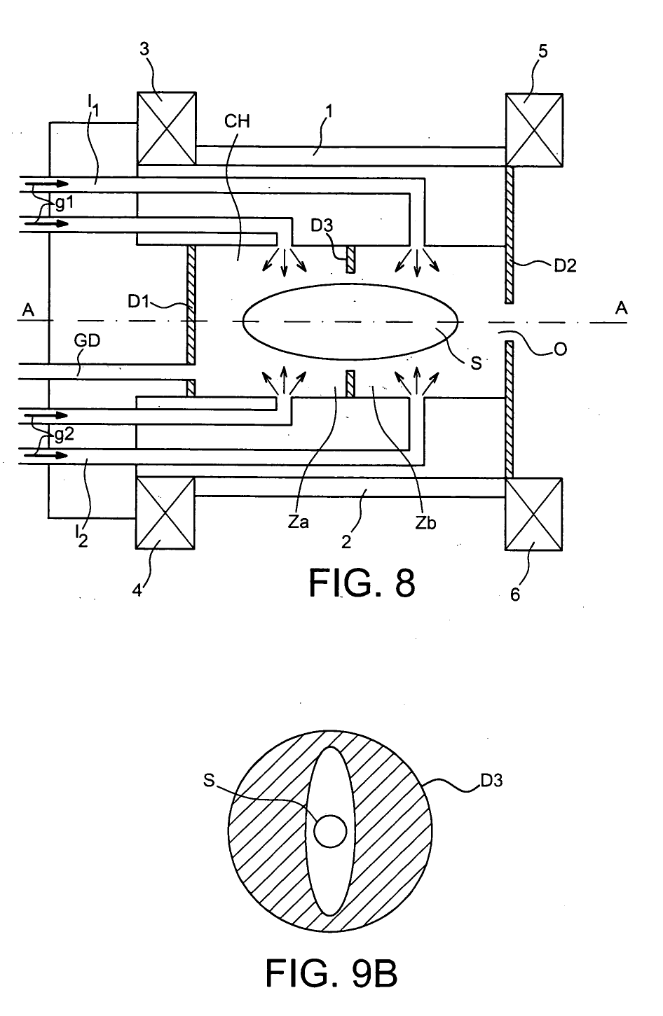

FIG. 8 shows a fifth variant of a photon source according to the invention. An additional diaphragm D3 is placed in the chamber CH between diaphragms D1 and D2, to advantageously increase the pressure gradient in the chamber. The diaphragm D3 then separates the chamber into two zones Za and Zb. Zone Za is a high pressure zone (typically 10⁻⁴ mbars) in which medium charge states are produced (for example Xe⁴⁺) and zone Zb is a low pressure zone (typically 10⁻⁷ mbars) in which higher charge states are produced (for example Cr¹⁹⁺). In both zones, the charge states produced can give photons with wavelength o as they are de-excited.

The shape of diaphragm D3 is adapted so that it does not disturb propagation of microwaves in the cavity. The size of the aperture in diaphragm D3 is then larger than the cut off wavelength of microwaves injected into the cavity. Furthermore, it is also desirable that the aperture in diaphragm D3 should not intercept magnetic field lines so that electrons and ions in the plasma can circulate freely from zone Za to zone Zb and vice versa. Magnetic field lines are determined using calculation programs (for example “Poisson-Superfish” type programs).

FIGS. 9A and 9b show examples of two forms of diaphragm D3 respecting the above conditions, with a hexapolar radial magnetic field (FIG. 9A) and a quadrupolar radial magnetic field (FIG. 9B). If the radial magnetic field is hexapolar, diaphragm D3 has a star-shaped central aperture with three arms, and said aperture surrounds the surface S of the plasma. More generally, diaphragm D3 has a star-shaped central aperture with N branches, in which the radial magnetic field is a field with 2N poles. When the radial magnetic field is quadrupole, diaphragm D3 has an ellipsoidal shaped central aperture that surrounds the surface S of the plasma.

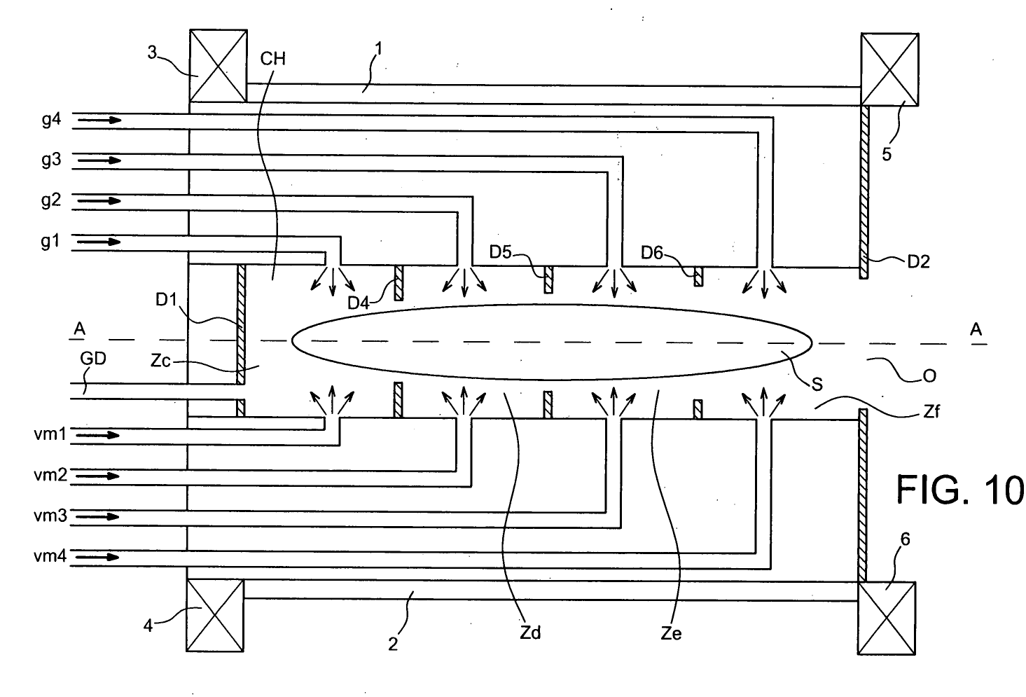

FIG. 10 shows a sixth variant of the photon source according to the invention. The chamber CH is divided into four distinct zones Zc, Zd, Ze, Zf separated by diaphragms D4, D5, D6. The diaphragms D4, D5, D6 are placed between the diaphragms D1 and D2, and for example the size of the apertures increases as the distance between the diaphragm D2 and the source output end reduces so as to prevent creating an obstacle to the propagation of photons towards the source outlet. As a non-limitative example, a gas g1 and a metallic vapour vm1 are injected into the zone Zc, a gas g2 and a metallic vapour vm2. are injected into the zone Zd, and a gas g3 and a metallic vapour vm3 are injected into the zone Ze, and a gas g4 and a metallic vapour vm4 are injected into the zone Zf. More generally, a photon source plasma chamber according to the invention can be divided into Q+1 zones where Q is an integer number greater than or equal to 1, separated from each other by Q diaphragms placed between the diaphragms D1 and D2 located at the two ends of the chamber. In the case of a cylindrical chamber, the apertures formed in the Q diaphragms are preferably aligned along the axis of the cylindrical chamber and surround the surface S of the plasma.

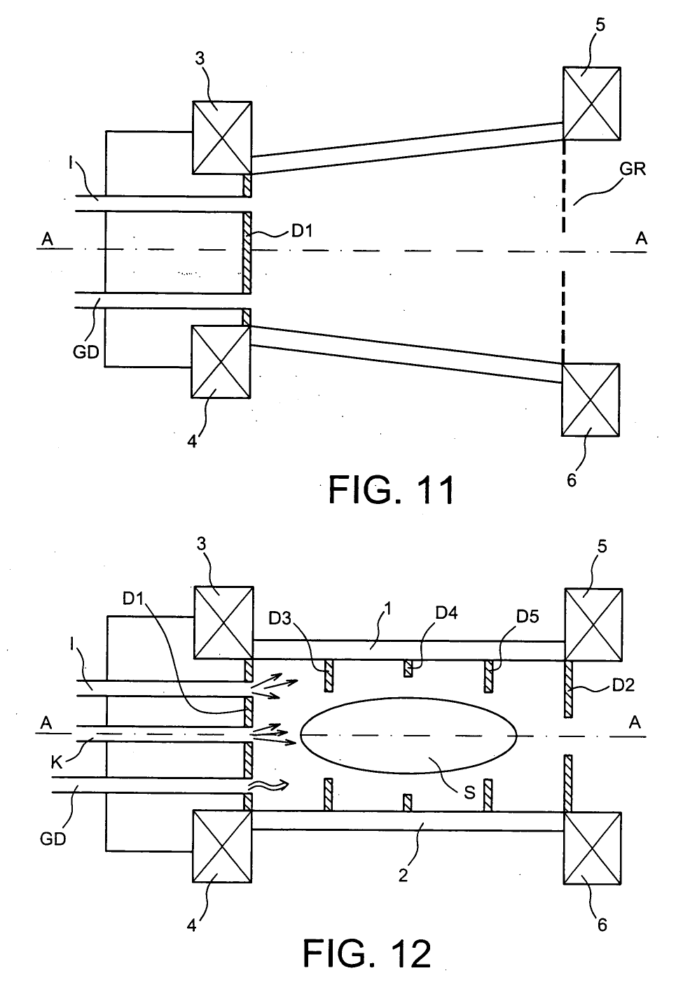

FIG. 11 shows another variant of the photon source according to the invention. The chamber CH is in the shape of a truncated cone. The output from the photon source is located on the large side of the truncated part of the cone while the gas and/or the metallic vapours inlet is located for example on the small side. A diaphragm in the form of a grid Gr provided with a central aperture prevents microwaves from exiting from the chamber CH. In this case, the truncated cone shape of the chamber is an essential means by which the pressure gradient is set up. Other embodiments of the invention (not shown in the figures) are obviously possible, combining the presence of all or some of the diaphragms mentioned above with the truncated cone shaped chamber.

FIG. 12 shows another variant of the photon source according to the invention.

In this other variant, the photon source comprises an external input of electrons. This external input of electrons may advantageously be chosen, for example in terms of quantity of electrons and/or electron energy, as a function of the charge states to be obtained for the constituents present in the chamber CH. An electron gun K, preferably aligned along the axis AA of the chamber CH, then emits electrons in the chamber CH. The electron density is thus increased to obtain multicharged ions that could produce photons at the required wavelength, by de-excitation. Intermediate diaphragms D3, D4 and D5 are present between the diaphragms D1 and D2.

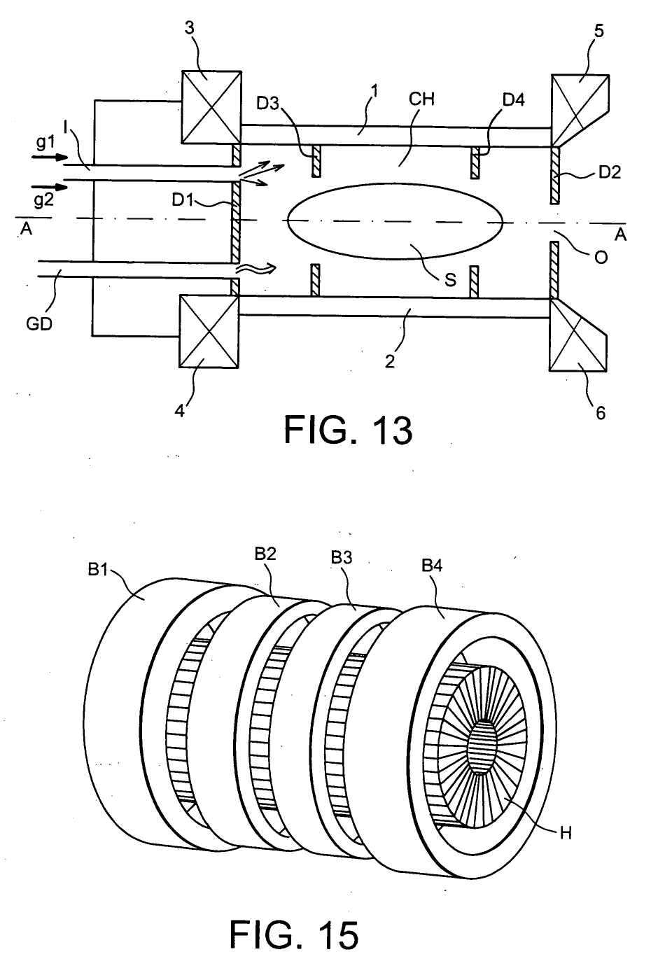

FIG. 13 shows yet another variant of the photon source according to the invention.

The cylindrical magnetic structure [5, 6] located at the photon extraction end is in the shape of a truncated cone on its inside diameter, the diameter of the truncated cone increasing with the displacement distance from inside the chamber towards the exit from the source. The photon emission zone is advantageously increased.

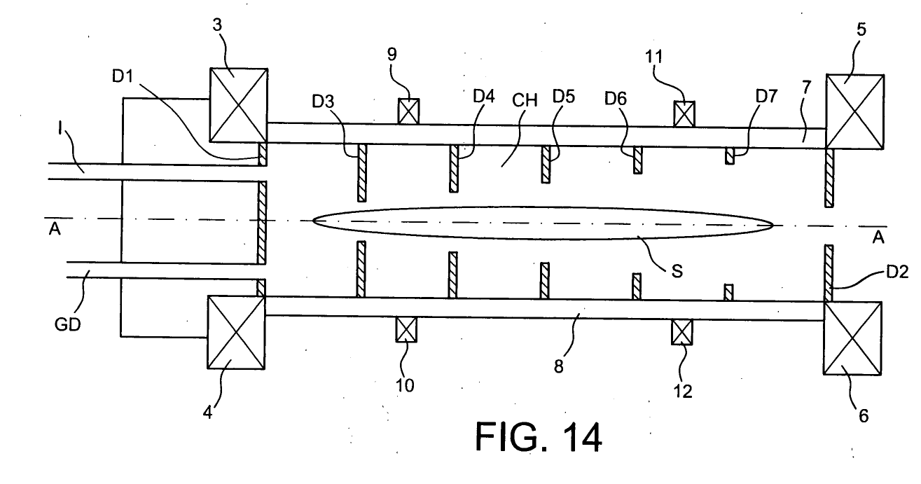

FIG. 14 shows yet another variant of the photon source according to the invention.

The photon source shown in FIG. 14 contains a fine strongly confined plasma for which the length along the AA axis of the chamber is greater than the length of the plasmas in the previous photon source. As a non-limitative example, the length of the strongly confined plasma can then be equal to 23 cm while the length of a non-confined plasma (see FIGS. 3, 5, 6, 8, 10, 12, 13) may for example be equal to 6 cm. In a manner known in itself, such an increase in the plasma length is obtained by moving the two cylindrical magnetic structures with axial confinement [3, 4] and [5, 6] further apart. The length of the chamber CH is then also increased, as is the length of the cylindrical magnetic structure with radial confinement [7, 8] that surrounds it. It is then necessary to place at least one additional structure with axial confinement between the magnetic structures [3, 4] and [5, 6] so to optimise the minimum value of the magnetic field, in a manner known in itself. As a non-limitative example, the photon source shown in FIG. 10 comprises two additional structures with axial confinement [9, 10] and [11, 12]. As a non-limitative example, intermediate diaphragms D3-D7 are present between the diaphragms D1 and D2. Advantageously, as the plasma length increases, the number of intermediate diaphragms between diaphragms D1 and D2 also increases, thus giving better control over the pressure gradient inside the chamber.

A strongly confined plasma produces a fine emission of photons that can increase the emitted power and also prevent any debris that might be produced by impacts of plasma particles on the chamber (phenomenon known as sputtering).

Other known means can also be used to increase the emitted power, for example such as the increase in the power and/or frequency of microwaves injected into the chamber CH through the injection guide GD. An emitter at 37 GHz can also be used outputting a continuous microwave power of 15 kW.

According to one variant of the invention, the magnetic structure that creates the axial magnetic field is composed, for example, of four superconducting axial windings B1, B2, B3, B4 as shown in FIG. 15. The windings B1 and B2 create maximum values of the magnetic field at the two ends of the chamber while windings B3 and B4 located between the windings Bl and B2 optimise the minimum values of this field. Windings B1, B2, B3 and B4 may for example be made from materials that are superconducting within a temperature range varying from 1.5° K. to 100° K. In this case the radial magnetic field is created by a hexapole H, for example composed of 24 permanent magnet sectors. According to one particular embodiment (not shown in the figures), the inside diameter of the winding B4 located at the photon extraction end is in the shape of a truncated cone, the diameter increasing with the distance from the inside of the chamber towards the exit from the source. The photon emission zone is advantageously enlarged, in the same way as in the case illustrated in FIG. 13.

With reference to the previous figures, the permanent magnets [7, 8], H used to radially confine the plasma have a limited remanence and coercitive field. The maximum values of the magnetic field can then not exceed 1.5 T. Superconducting coils can be used to create the radial magnetic field, so as to build more powerful photon sources operating with high frequency microwaves, for example frequencies within the range 18 GHz-24 GHz (or frequencies even greater than this range).

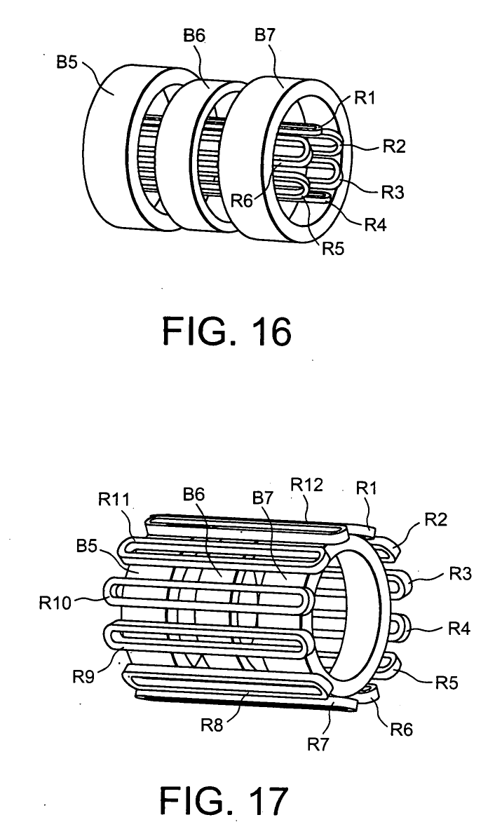

FIG. 16 shows a variant magnetic structure according to the invention in which superconducting coils R1-R6 are used to create the radial magnetic field. The magnetic structure of the ECR source is then entirely made using superconducting windings. As a non-limitative example, three superconducting windings B5, B6, B7 create the axial confinement of the magnetic field while six superconducting windings R1-R6 create the radial confinement. The six superconducting windings R1-R6 may for example be hexapoles (three North poles/three South poles, one North pole alternating with a South pole) of a type commonly called a “racetrack”. According to a first particular embodiment, the superconducting coils that create the radial magnetic field and/or the axial magnetic field are composed of a superconducting material for which the critical temperature is sufficiently low so that it can be used, for example, at a temperature less than 5° K. According to another particular embodiment, the superconducting material is said to be “High Temperature Superconducting (HTS)” so that it can be used, for example, at a temperature of the order of 70° K.

According to another variant of the invention, the radial confinement windings can also be placed outside the structure with axial confinement as shown in FIG. 17. This variant is advantageous in some cases for size reasons. The radial magnetic field may for example be twelve-pole made by twelve windings R1-R12 of the “racetrack” type (six North poles alternating with six South poles).

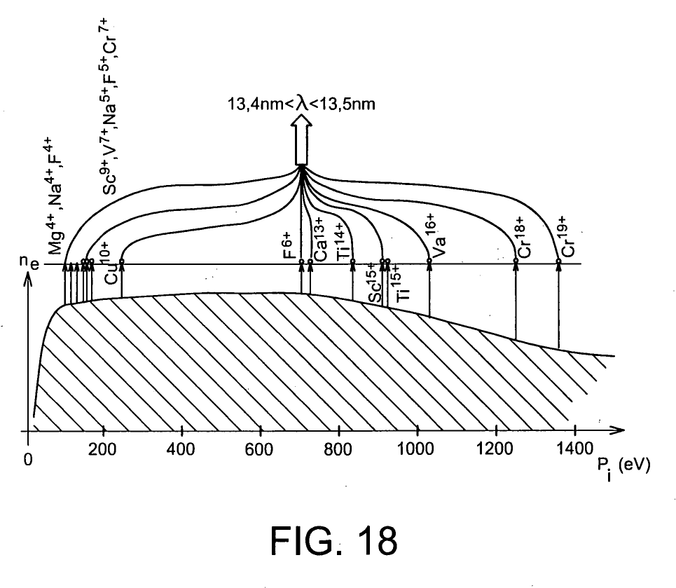

FIG. 18 shows an example of an electronic density distribution curve ne in an ECR plasma as a function of the ionisation potential Pi of constituents with an atomic number less than 36, within the framework of the invention. This curve should be compared with the curve in FIG. 2 that corresponds to the case in which the photon source does not have specific means of setting up a pressure gradient in the chamber.

In this case the pressure gradient applies a “high” pressure for constituents that require a relatively low ionisation potential (a few tens of eV) and a “low” pressure for constituents that require a higher ionisation potential (a few hundred eV). The pressure gradient then advantageously increases the electron density in the plasma and consequently the density of ions that could emit photons by de-excitation.

### REFERENCES

[1] American patent application No. 20030006708 entitled “Microwave ion source”, K. N. Leung, J. Reijonen, R. Thomae, deposited on Jan. 9, 2003.

[2] “All-permanent magnet ECR plasma for EUV light”, D. Hitz, M. Delaunay, E. Quesnel, C. Vannuffel, P. Michallon, A. Girard, L. Guillemet, 3^{rd} EUVL symposium (November 2004), Miyazaki, Japan.

[3] “An all-permanent magnet ECR ion source for the ORNL MIRF upgrade project”, D. Hitz et al., 16 International Workshop on ECR Ion Source ECRIS'04, Sep. 20-30, 2004; Berkeley USA.

“Atomic Data and Nuclear Data Tables”, volume 36, p. 167-353 (1987), H. Tawara, T. Kato.

1. Photon source comprising an electron cyclotron resonance (ECR) multicharged ion plasma source, the multicharged ions corresponding to several charge states of a first constituent (g1) inserted into a vacuum chamber (CH), and at least one charge state emitting photons with a wavelength λₒ by de-excitation, wherein means set up a pressure gradient within the chamber (CH) of the first constituent (g1) and/or at least one second constituent (g2) different from the first constituent (g1), the pressure gradient being capable of creating an energy gradient of plasma electrons such that additional multicharged ions corresponding to at least one charge state of the first constituent (g1) and/or at least one charge state of the second constituent (g2) are created in the chamber, the additional multicharged ions emitting photons with a wavelength equal to approximately λₒ by de-excitation.

2. Photon source according to claim 1, wherein the means of setting up a pressure gradient include a first diaphragm (D1) located on a first side of the chamber and a second diaphragm (D2) located on a second side of the chamber opposite the first side, in which there is an aperture through which photons are extracted from the photon source.

3. Photon source according to claim 2, wherein the second diaphragm (D2) comprises a central orifice (O) through which photons are extracted from the photon source and pumping holes (t) distributed around the central orifice, the diameter of the pumping holes (t) being chosen to prevent microwaves injected into the cylindrical chamber (CH) under a vacuum from leaving the chamber, the number of pumping holes being chosen in relation with the hole diameter to set up a pressure value of the first constituent (g1) and/or the second constituent (g2) in a zone of the chamber located close to the second diaphragm.

4. Photon source according to claim 3, wherein the second diaphragm (D2) is made of a conducting material and is polarised either to capture ions on impact zones (E1, E2, E3) and to transfer electrons to the plasma, or to capture electrons on impact zones (E1, E2, E3) and to transfer ions to the plasma.

5. Photon source according to claim 1, wherein Q additional diaphragms (D3, D4, D5, D6) are placed between the first and the second diaphragms such that the chamber is divided into Q+1 zones.

6. Photon source according to claim 5, wherein each of the Q additional diaphragms (D3, D4, D5, D6) comprises an aperture with a size greater than a cut-off wavelength of microwaves injected into the chamber.

7. Photon source according to claim 6, wherein the shape of the aperture of each of the Q additional diaphragms is such that it does not intercept the lines of a magnetic field present in the chamber, thus leaving plasma particles free to circulate between the Q+1 zones.

8. Photon source according to claim 5, wherein at least one additional diaphragm (D3, D4, D5, D6) is made from a conducting material and is polarised to capture or to transfer ions or electrons to the plasma.

9. Photon source according to claim 5, wherein the first constituent (g1) and/or the second constituent (g2) are inserted into at least one of the Q+1 zones of the chamber.

10. Photon source according to claim 1, wherein the chamber is in a truncated cone shape and participates in the means of setting up the pressure gradient.

11. Photon source according to claim 1, wherein pumping means (P) participate in the means of setting up a pressure gradient.

12. Photon source according to claim 1, wherein means (K) introduce additional electrons into the chamber (CH).

13. Photon source according to claim 1, wherein the first constituent (g1) and/or the second constituent (g2) is a gas or a metal vapour.

14. Photon source according to claim 1, wherein a magnetic structure that participates in the multicharged ion plasma source comprises two cylindrical magnetic structures ([3,4], [5,6]) with axial confinement of the magnetic field and a cylindrical magnetic structure ([7,8]) with radial confinement of the magnetic field that surrounds the chamber (CH) and that is located between the two cylindrical magnetic structures with axial confinement, a first cylindrical magnetic structure with axial confinement being located at a first end of the chamber and the second cylindrical magnetic structure with axial confinement being located at a second end of the chamber where the photons are extracted from the source.

15. Photon source according to claim 14, wherein at least one additional cylindrical magnetic structure with axial confinement ([9,10], [11,12]) is located between the two cylindrical magnetic structures with axial confinement located at the two ends of the chamber (CH).

16. Photon source according to claim 15, wherein the cylindrical magnetic structures with axial confinement and the additional cylindrical magnetic structure with axial confinement are composed of superconducting coils.

17. Photon source according to claim 16, wherein the cylindrical magnetic structure with radial confinement is composed of superconducting coils.

18. Photon source according to claim 17, wherein the superconducting coils that form the cylindrical magnetic structure with radial confinement are located inside the superconducting coils that form magnetic structures with axial confinement.

19. Photon source according to claim 17, wherein the superconducting coils that form the cylindrical magnetic structure with radial confinement are outside the superconducting coils that form the magnetic structures with axial confinement.

20. Photon source according to claim 17, wherein the superconducting coils that form the cylindrical magnetic structure with radial confinement are “racetrack” type coils.

21. Photon source according to claim 14, wherein the cylindrical magnetic structure with radial-confinement is composed of permanent magnets.

22. Photon source according to claim 14, wherein the inside diameter of the cylindrical magnetic structure with axial confinement located at the second end of the chamber increases with increasing distance from the inside of the chamber towards the exit from the chamber.

23. Photon source according to claim 1, wherein wavelength λₒ is equal to approximately 13.5 nm.
